(19) United States
(12) Patent Application Publication
(10) Pub. No.: US 2026/0369135 A1
(43) Pub. Date: Nov. 19, 2026

(54) GAME OR AMUSEMENT MACHINE FOR PLAYING ONLINE AND OFFLINE

(71) Applicant: ELAUT N.V., Sint-Niklaas (BE)

(72) Inventors: Laurens DE SMEDT, Sint-Niklaas (BE); Eric VERSTRAETEN, Sint-Niklaas (BE)

(73) Assignee: ELAUT N.V., Sint-Niklaas (BE)

(21) Appl. No.: 19/143,170

(22) PCT Filed: Dec. 22, 2023
(86) PCT No.: PCT/EP2023/087680

§ 371 Date: Jun. 25, 2025

(30) Foreign Application Priority Data
Dec. 26, 2022 (BE) 2022/6092
Jun. 2, 2023 (BE) 2023/5453

(51) Int. Cl. G07F 17/32

(52) U.S. Cl. CPC G07F 17/3297; G07F 17/3209; G07F 17/3218; G07F 17/323; G07F 17/3253

(57) ABSTRACT

A game or amusement machine, such as a claw machine, comprising a housing with a playing means; a control means configured for controlling the playing means, and a user interface, such as buttons and/or joystick, provided to said housing and controllable by an offline player, said user interface configured to generate signals to control the playing means; wherein said control means is further configured to receive signals to control the playing means, from a remote device of an online player, such as a home computer or a mobile device, to play a game online; wherein the control means is configured to operate in an offline mode or in an online mode, wherein in the offline mode the control means is configured to use signals received from the user interface, and wherein in the online mode the control means is configured to use signals received from the remote device.

### TECHNICAL FIELD

The present invention relates to a game or amusement machine, such as a claw machine or a machine of the pusher type or any other arcade redemption or merchandising game, comprising a housing with a playing area and a playing means. The playing area may be a playing area in which one or more objects, such as prizes or playing pieces, are present.

### BACKGROUND

In present times where people increasingly flock towards their online services for entertainment, communication and community, out-of-home entertainment offers a welcome escape by offering physical, real-life experiences. Theme and attraction parks, family entertainment centers, fun fairs and arcades hold their ground by doubling down on electromechanical experiences and machines to entertain young and old. This explains the steady and even growing popularity of claw machines, coin pushers and other electromechanical arcade games. However, a shift can be observed in consumer and customer expectations towards leveraging digital technologies to enhance the physical experience, e.g. apps in attraction parks to measure queuing times, digital monitors to bonus games on coin pushers, card swipe systems to measure income reports of all games in an arcade etc.

Following this trend, (web) apps have been introduced, offering real live arcade games which can be controlled via live streaming over the internet. These games use specifically designed machines set up in a large warehouse, to be accessed worldwide, controlled by a remote device connected to the internet, without the need for a joystick or buttons.

### SUMMARY

The object of embodiments of the invention is to provide an improved game or amusement machine.

According to a first aspect, there is provided a game or amusement machine, such as a claw machine or a machine of the pusher type or any other arcade redemption or merchandising game. The game machine comprises a housing with a playing area and a playing means, a control means configured for controlling the playing means, and a user interface, such as one or more buttons and/or a joystick. The user interface is provided to the housing and controllable by an offline player. The user interface is configured to generate signals to control the playing means. The control means is configured to receive signals to control the playing means, from a remote device of an online player, such as a home computer or a mobile device of the online player, to play a game online. The control means is configured to operate in an offline mode or in an online mode, wherein in the offline mode the control means is configured to allow the use of signals received from the user interface, and in the online mode the control means is configured to use signals received from the remote device.

Embodiments of the invention have the features of any one of the enclosed claims.

Embodiments of the invention relate to an arcade game machine that can be played both online and offline. The machine can not only be played in a warehouse but also within an arcade where visitors can play offline and watch other players playing online. By having a user interface and control means as defined in claim 1, an arcade machine can be played both online and offline in an improved manner. In this way, the arcade machine can be played more often during opening hours but also when the arcades are closed due to seasonality, closing hours, etc., resulting in a higher return on investment.

Preferably, the machine further comprises at least one camera arranged for obtaining images of at least a portion of the playing area, and the control means is further configured for sending images obtained by the camera, optionally in processed form, to the remote device. For example, the machine may comprise a top camera and/or a front camera. The front camera may be arranged inside the housing or outside the housing. Such images may be sent whilst a player is playing an on-line game and/or whilst playing off-line and/or in an idle status when no one is playing. In yet another embodiment, a camera may be arranged outside the housing and may be shared by more than one machine.

Preferably, the game of amusement machine further comprises one or more objects, such as one or more prizes, in said playing area, and the playing means is configured to manipulate the one or more objects. For example, the one or more objects may comprise prizes and the playing means may be a gripper, or the one or more objects may comprise playing pieces and the playing means may comprise a pusher, or the one or more objects may comprise a ball and the playing means may comprise a rotating disc with holes or any other target for the ball, etc. In a possible embodiment, a camera may be attached to the playing means, e.g., to a gripper. In that manner a good view can be obtained of the relevant portion of the playing area. Images captured by the camera may then be sent by the control means to the remote device, e.g., during an on-line game and/or during an off-line game and/or in an idle status when no one is playing.

Optionally, the housing is provided with a first compartment which is freely accessible to an offline player and a second compartment which is not freely accessible to an offline player, and the control means is configured to move an object to the first compartment when playing in the offline mode and to the second compartment when playing in the online mode. In yet other embodiments, an object may also be moved to a non-accessible compartment when playing in the offline mode. In that manner, when an online player wins a prize, it may be dropped in the second compartment and collected at a later time, whilst a prize won by an offline player may be directly dropped in the first compartment.

Optionally, the housing may be provided with a lockable door to access the second compartment. In that manner a prize won by an online player may be collected at any time by an operator of the machine.

Optionally, the control means is configured to issue a voucher to an online and/or offline player when an object, such as a prize is moved to a non-accessible compartment, such as the second compartment. The voucher may then be used by the online and/or offline player to collect the prize at a later time or to get any other form of compensation for the prize won.

Optionally, the machine further comprises a transport mechanism, optionally comprising the playing means (for example, when the playing means is a gripper, the gripper may also be used as a transport mechanism), configured to transport one or more objects won by an offline and/or an online player back to the playing area. Optionally, the control means may then be configured to issue a voucher to the offline and/or online player. In this manner a prize won may be automatically returned to the playing area without requiring the intervention of an operator.

Optionally, the machine further comprises an object movement means, such as a rotator, configured to move an object in the playing area. In this manner, the game may be made more entertaining. It is noted that both the off-line player and the online player see the object moving.

Optionally, the control means is configured to be set in at least two of the following modes, preferably all three of the following modes:
a manual mode in which an object won by an offline or online player is to be put back on the playing area by an operator; wherein the control means is configured to send a message to an operator when an object is won;
an automatic mode in which an object won by an offline or online player is automatically dispensed back to the playing area; for example, the object won may be automatically returned to the playing area using a transport mechanism;
a prize dispensing mode in which an object won by an offline or online player is dispensed to a compartment.

In this manner, in function of the wishes of the operator, the control means may be set in any suitable mode.

Optionally, the user interface is configured for allowing an offline player to input a request to play a game using the user interface, wherein the control means is further configured to receive an online request to play a game online, from the remote device, and wherein the control means is configured to schedule a sequence of games based on requests received from the user interface and/or from the remote device; and to allow the use of signals received from the user interface or signals received from the remote device, according to the scheduled sequence.

Preferably, the control means is provided with a queuing mechanism configured to order and store the received requests. For example, when a new request to play online is received it may be put at the end of the queue.

Optionally, the queuing mechanism is configured to give priority to a request received from the user interface, i.e. a request received from an offline player. Preferably, the queuing mechanism is configured to put a request received from the user interface before any pending online requests stored in the queuing mechanism. In this manner, priority is given to offline players.

Optionally, the control means is configured to end a game that is being played online within a determined time period when a request is received from the user interface. In this way priority may be given to offline players.

Optionally, the control means is configured to inform the remote device that a game will be ended within a determined time period when a request is received from the user interface. For example, when an offline player enter a request to play offline via the user interface, an online player may be warned that only a limited amount of time, e.g. between 20 and 60 seconds, is left to finish the game. Also, the offline player may be informed that the game of the online player will finish within a determined amount of time, e.g. by displaying a suitable message of a display of the machine.

Optionally, the control means is configured to inform an offline player, e.g. by displaying a message on a display of the machine, that an online player is watching the game and/or that an online player has requested to play a game.

Optionally, the control means is configured to inform the remote device, i.e. to inform an online player, that an offline player is playing a game.

Optionally, the housing is provided with a display connected to the control means and configured to display a list of offline and/or online players associated with scheduled sequence of games. In addition or alternatively, the display may be configured to display any messages to inform an offline player about the status of a game played by an online player.

In an exemplary embodiment, the playing means comprises a pick-up means, such as a claw device, a grabber or vacuum head, configured to pick-up one or more objects. Preferably, the playing means may further comprise a positioning means controllable by the user interface or the remote device for placing the pick-up means over one or more objects.

Preferably, the control means is configured to control the positioning means and the pick-up means to bring a won object back on the playing area after an offline or online player has won an object. In this way, an object, typically a prize, may be brought back into the playing area in an automated manner.

Optionally, the control means may be configured to lower the pick-up means with a won object in a win chute without dropping the object, and to lift the object up again out of the win chute with the won object, whereupon the positioning means are controlled to move the object back above the playing area followed by controlling the pick-up means to drop the object. In this way, an object, typically a prize, may be brought back into the playing area in an automated and fast manner.

Optionally, the playing means comprises a manipulation device configured to add and/or manipulate one or more objects, such as one or more prizes and/or one or more playing pieces, such as coins, tokens, chips and/or balls, in the playing area.

Preferably, the machine further comprises a detection means configured for detecting an object won by an online or offline player. The control means may then be configured to receive a detection signal from the detection means and to inform the online or offline player accordingly.

According to an exemplary embodiment, the one or more objects comprise a plurality of playing pieces and optionally one or more prizes in the playing area. The machine may comprise a playing piece pusher configured to move over the playing area at successive points in time in order to disturb the playing pieces and the optional one or more prizes in the playing area. The playing area and the playing piece pusher are arranged such that one or more playing pieces and/or prizes can drop over an edge of the playing area during movement of the playing piece pusher. This is a machine which is known as a machine of the pusher type. Optionally, the machine may further comprise a transport mechanism configured to transport one or more playing pieces and/or prizes which have dropped over the edge and to reintroduce the one or more playing pieces and/or prizes onto the playing area. The control means may be further configured to control the transport mechanism, optionally based on signals received from the user interface or the remote device. When playing pieces and prizes are present in the machine, the transport mechanism may comprise for example a first closed-loop mechanism configured to transport playing pieces and a second closed-loop mechanism configured to transport prizes.

According to a second aspect there is provided a control means for use with a game or amusement machine comprising a playing means and a user interface manipulable by an off-line user to control the playing means. The control means is configured to operate in an offline mode or in an online mode. The control means is further configured to receive signals to control the playing means, from a remote device of an online player, such as a home computer or a mobile device of the online player, when in the on-line mode, and to allow using signals received from the user interface, when in the off-line mode.

Such control means may be provided as a kit which can be added to any new or existing game or amusement machine. In other words, the control means may be implemented as a kit capable of bringing an existing amusement machine in an offline or in an online mode. For example, an operator may allow both online and offline playing on the amusement machine by installing this kit.

Preferably, the control means is configured to receive an online request to play a game online, from the remote device, to schedule a sequence of games based on requests received from the user interface and/or from the remote device, and to control the machine so as to use signals received from the user interface or signals received from the remote device, according to the scheduled sequence.

Preferably, the control means is provided with a queuing mechanism configured to order and store the received requests. Optionally, the queuing mechanism is configured to give priority to a request received from the user interface, and preferably to put a request received from the user interface before any pending online requests stored in the queuing mechanism.

Optionally, the control means is configured to end a game that is being played online within a determined time period when a request is received from the user interface, i.e. from an offline player. Optionally, the control means is configured to inform the remote device and/or the offline player, e.g. by displaying a message on a display of the machine, that a game will be ended within a determined time period when a request is received from the user interface.

Preferably, the control means is configured for sending images obtained by a camera of at least a portion of a playing area of the machine, optionally in processed form, to the remote device. Thus, the control means may send images of the game to the remote device, e.g., whilst playing online and/or whilst playing off-line and/or in an idle status of the machine when no-one is playing.

According to another aspect there is provided an assembly comprising a control means of any one of the embodiments described above, and a display connected to the control means and configured to display a list of offline and/or online players associated with scheduled sequence of games.

Optionally, the assembly may further comprise at least one camera connected to the control means and configured to capture images of at least a portion of the playing area.

According to a further aspect, there is provided a machine according to any one of the following clauses. By offering the different operating modes, cf. below, to an operator can more flexibly operate the machine depending on his needs. It is noted that the game or amusement machine of clause 1 may be a machine which is only used offline. It may also be a machine which is used both online and offline.
1. A game or amusement machine (1), such as a claw machine or a machine of the pusher type or any other arcade redemption or merchandising game, comprising:
   a housing (10) with a playing area (70) and a playing means (20);
   one or more objects, such as one or more prizes, in said playing area, wherein the playing means is configured to manipulate the one or more objects;
   a control means (30) configured for controlling the playing means, and
   a user interface (40), such as one or more buttons and/or a joystick, provided to said housing and controllable by a player, said user interface being configured to generate signals to control the playing means;
wherein the control means is configured to be set in at least two of the following modes, preferably all three of the following modes:
a manual mode in which an object won by a player is to be put back on the playing area by an operator; wherein preferably the control means is configured to send a message to an operator when an object is won;
an automatic mode in which an object won by a player is automatically dispensed back to the playing area; wherein preferably the object won may be automatically returned to the playing area using a transport mechanism;
a prize dispensing mode in which an object won by a player is dispensed to a compartment.
2. The game or amusement machine of the previous clause, wherein, in the prize dispensing mode, when the machine is operating in an offline mode, the object won is registered automatically by the game or amusement machine and given out to the player who is playing in front of the machine.
3. The game or amusement machine of clause 1, wherein, in the prize dispensing mode, when the machine is operating in an online mode, the object won is registered automatically by the game or amusement machine, is placed in a spare compartment, and a voucher is provided to the on-line player.
4. The game or amusement machine of any one of the previous clauses, wherein said control means is configured to receive signals to control the playing means, from a remote device (2, 2′) of an online player, such as a home computer or a mobile device of the online player, to play a game online; wherein the control means is configured to operate in an offline mode or in an online mode, wherein in the offline mode the control means is configured to allow the use of signals received from the user interface, and wherein in the online mode the control means is configured to use signals received from the remote device.
5. The machine of clause 4, further comprising at least one camera arranged for obtaining images of at least a portion of the playing area, wherein said control means is further configured for sending images obtained by the camera, optionally in processed form, to the remote device.
6. The machine of any one of the previous clauses, wherein the housing is provided with a first compartment (81) which is freely accessible to an offline player and a second compartment (82) which is not freely accessible to an offline player, and wherein the control means is configured to move an object to the first compartment when playing in the offline mode and to the second compartment when playing in the online mode.
7. The machine of clause 6, wherein the housing is provided with a lockable door to access the second compartment.
8. The machine of any one of the previous clauses, wherein the control means is configured to issue a voucher to a player when an object is won and moved to a non-accessible compartment or back to the playing area.
9. The machine of any one of the previous clauses, further comprising a transport mechanism (90), optionally comprising the playing means, configured to transport one or more objects won by a player back to the playing area, and, wherein in the automatic mode the control means is configured to issue a voucher to the player.
10. The machine of any one of the previous clauses, further comprising an object movement means (75), such as a rotator, configured to move an object in the playing area.
11. The machine of any one of the previous clauses, wherein the playing means comprises a pick-up means, such as a claw device, a grabber or vacuum head, configured to pick-up one or more objects.
12. The machine of clause 11, wherein the playing means further comprises a positioning means controllable by the user interface or the remote device for placing the pick-up means over one or more objects.
13. The machine of clause 5 and 11 or 12, wherein a camera of said at least one camera is attached to the pick-up means and/or to the positioning means.
13. The machine of clause 12, wherein, in the automatic mode the control means is configured to control the positioning means and the pick-up means to bring a won object back in the playing area after a player has won an object.
14. The machine of clause 13, wherein, in the automatic mode the control means is configured to lower the pick-up means with a won object in a win chute without dropping the object, and to lift the object up again out of the win chute with the won object, whereupon the positioning means are controlled to move the object back above the playing area followed by controlling the pick-up means to drop the object.
15. The machine of any one of the previous clauses, wherein the playing means comprises a manipulation device configured to add and/or manipulate one or more objects, such as one or more prizes and/or one or more playing pieces, such as coins, tokens, chips and/or balls, in the playing area.
16. The machine of any one of the previous clauses, further comprising a detection means configured for detecting an object won by an online or offline player, wherein the control means is configured to receive a detection signal from the detection means and to inform the online or offline player accordingly.
17. The machine any one of the previous clauses, wherein the one or more objects comprise a plurality of playing pieces and optionally one or more prizes in the playing area.
18. The machine of clause 17, further comprising a playing piece pusher configured to move over the playing area at successive points in time in order to disturb the playing pieces and the optional one or more prizes in the playing area, wherein the playing area and the playing piece pusher are arranged such that one or more playing pieces and/or prizes can drop over an edge of the playing area during movement of the playing piece pusher.
19. The machine of clause 18, wherein the playing means comprise a transport mechanism configured to transport one or more playing pieces and/or prizes which have dropped over the edge and to reintroduce the one or more playing pieces and/or prizes onto the playing area.
20. The machine of clause 19, wherein the control means is configured to control the transport mechanism, optionally based on signals received from the user interface or the remote device.
21. The machine of clause 19 or 20, wherein the transport mechanism comprises a first closed-loop mechanism configured to transport playing pieces and a second closed-loop mechanism configured to transport prizes.

### BRIEF DESCRIPTION OF THE DRAWINGS

The present invention will be further elucidated on the basis of a number of by no means limitative exemplary embodiments with reference to the accompanying drawings, in which:

FIGS. 1-4 illustrate schematically an embodiment of an arcade machine in different stages of the game.

FIGS. 5 and 6 are a perspective schematic front view and a schematic side view of an exemplary embodiment of a machine of the pusher type.

FIG. 7 is a flow diagram illustrating how a control means kit may be added to an existing machine according to an exemplary embodiment.

FIG. 8 is a flowchart illustrating a sequence of steps controlled by an exemplary embodiment of a control means.

FIGS. 9A and 9B illustrate a top view of an embodiment of an arcade machine with two cameras.

FIGS. 10A-10F illustrate examples of windows displayed on a remote device.

FIG. 11 is a flowchart illustrating a sequence of steps controlled by another exemplary embodiment of a control means.

### EXEMPLARY EMBODIMENTS

Combining physical (offline) and online play, creates several challenges, which can be summarized in three main ones:
i. Technologically: state-of-the-art arcade machines can only be controlled via a joystick or online, but do not allow interaction, switching and prioritization between the two input sources (user interface provided to the housing and remote device).
ii. User experience: Trying to control an arcade game that can be controlled via several separate input sources can be confusing for players, especially if these input sources may be half a globe apart.
iii. Physically: in a prior art machine any prize or token value that is dispensed by the physical machine may be picked up (and redeemed) by players physically standing in front of the machine. This would mean that prizes dispensed for players playing online can be taken by players in the physical arcade.

Embodiments of the invention relate to an arcade game which overcomes one or more of said problems.

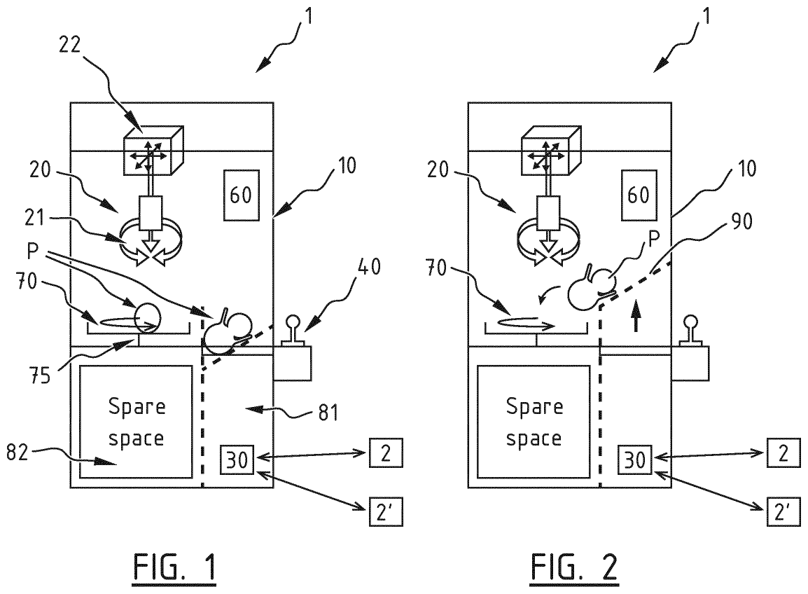

FIG. 1 illustrates a claw machine 1, but the principles of the invention are generally applicable on any type of game or amusement machine. For example, the machine may be a coin pusher, a pinball machine, a ball manipulation machine, such as a ball drop machine where a user interface with a button can controlling the dropping of a ball on a rotating disc with holes, etc.

The claw machine 1 of FIG. 1 comprises a housing 10 in which a playing area 70 and a playing means 20 are arranged. The machine 1 further comprises a control means 30 (represented schematically) configured for controlling the playing means 20, and a user interface 40, such as one or more buttons and/or a joystick, provided to the housing 10 and controllable by an offline player. The user interface 40 is configured to generate signals to control the playing means 20. The control means 30 is configured to receive signals to control the playing means 20, from a remote device 2, 2′ of an online player, such as a home computer or a mobile device of an online player, to play a game online.

The control means 30 is configured to operate in an offline mode or in an online mode, wherein in the offline mode the control means 30 is configured to allow the use of signals received from the user interface 40, and in the online mode the control means 30 is configured to use signals received from a remote device 2, 2′.

Typically, the game or amusement machine 1 further comprises one or more objects, typically one or more prizes in the case of a claw machine, in the playing area 70, and the playing means 20, here comprising a gripper 21, is configured to manipulate the one or more objects, here in the form of prizes P.

The housing 10 may be provided with a first compartment 81 which is freely accessible to an offline player and a second compartment 82 which is not freely accessible to an offline player. The control means 30 may then be configured to move an object to the first compartment 81 when playing in the offline mode and to the second compartment 82 when playing in the online mode. The housing 10 may be provided with a lockable door (not shown) to access the second compartment 82. The control means 30 may be configured to issue a voucher to an online player when an object, such as a prize P is moved to the second compartment 82.

Optionally, the machine may comprise a separate transport mechanism 90 configured to transport one or more objects won by an offline and/or an online player back to the playing area 70. In an alternative embodiment, the playing means 20 itself may be used to transport one or more objects won by an offline and/or an online player back to the playing area 70. Also, a combination of the playing means 20 and an additional transport device may be used for this purpose. In case of such closed-loop system, the control means 30 may then be configured to issue a voucher to the offline and/or online player when a prize is won.

Optionally, the machine may comprise an object movement means 75, such as a rotator, configured to move an object P in the playing area 70.

Optionally, the control means 30 is configured to be set in at least two of the following modes, preferably all three of the following modes:
a manual mode in which an object, such as a prize P, won by an offline or online player is to be put back in the playing area 70 by an operator; the control means 30 may then be configured to send a message to an operator when an object is won;
an automatic mode in which an object won by an offline or online player is automatically dispensed back to the playing area 70, e.g. using the transport mechanism 90 and/or the playing means 20;
a prize dispensing mode in which an object won by an offline or online player is dispensed to a compartment, e.g. the first compartment 81 in case of an offline player and the second compartment 82 in case of an online player.

Preferably, the user interface 40 is configured for allowing an offline player to input a request to play a game using the user interface 40. This may for example be done by allowing a user to insert a coin and/or pay a credit and to press a start button. The control means 30 receives such request and is configured to schedule a game. The control means 30 is further configured to receive an online request to play a game online, from the remote device 2, 2′. Similarly, an online player may pay and indicate on a screen of the remote device 2, 2′ that he wishes to start a game. The control means 30 is configured to schedule a sequence of games based on requests received from the user interface 40 and/or from the remote device 2, 2′; and to use signals, such as playing commands, received from the user interface 40 or signals, such as playing commands, received from the remote device 2, 2′, according to the scheduled sequence. Thus, the control means 30 may decide the order to the games, and may function as a switching interface, passing on the signals received from the remote device 2, 2′ or from the user interface 40 depending on whether the game is being played by an online or an offline player.

Preferably, the control means 30 is provided with a queuing mechanism configured to order and store the received requests. The queuing mechanism may be configured to give priority to a request received from the user interface 40, and preferably to put a request received from the user interface 40 before any pending online requests stored in the queuing mechanism. In that manner, priority is given to an offline player, and an online player may be put in the queue until an offline player is finished. The control means 30 may be configured to end a game that is being played online within a determined time period when a request is received from the user interface 40, so that an offline player does not have to wait long before being able to start a game. The control means may then be configured to inform the remote device and/or the offline player that a game will be ended within a determined time period when a request is received from the user interface 40. To that end the control means 30 may send a suitable message, e.g. via a suitable wired and/or wireless communication network, to the remote device 2, 2′, so that the online player is timely informed. Optionally, any remaining credits may then be paid out to the online player.

Optionally, the housing is provided with a display 60 connected to the control means 30 and configured to display information related to the games that are being played on the machine, e.g., a list of offline and/or online players associated with scheduled sequence of games.

In the exemplary embodiment of FIGS. 1-4, the playing means 20 comprise a pick-up means 21, such as a claw device, a grabber, a gripper or a vacuum head, configured to pick-up one or more objects P. The playing means 20 further comprises a positioning means 22 controllable by the user interface 40 or the remote device 2, 2′ through the control means 30 for placing the pick-up means 21 over one or more objects. Typically, the positioning means 22 is configured to move the pick-up means 21 in an X, Y and Z direction. The control means 30 is configured to control the positioning means 22 and the pick-up means 21 to bring a won object back in the playing area after an offline or online player has won an object.

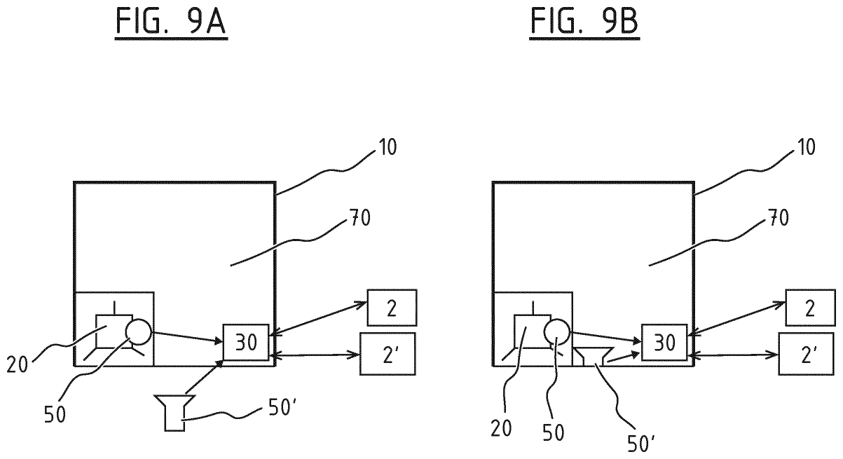

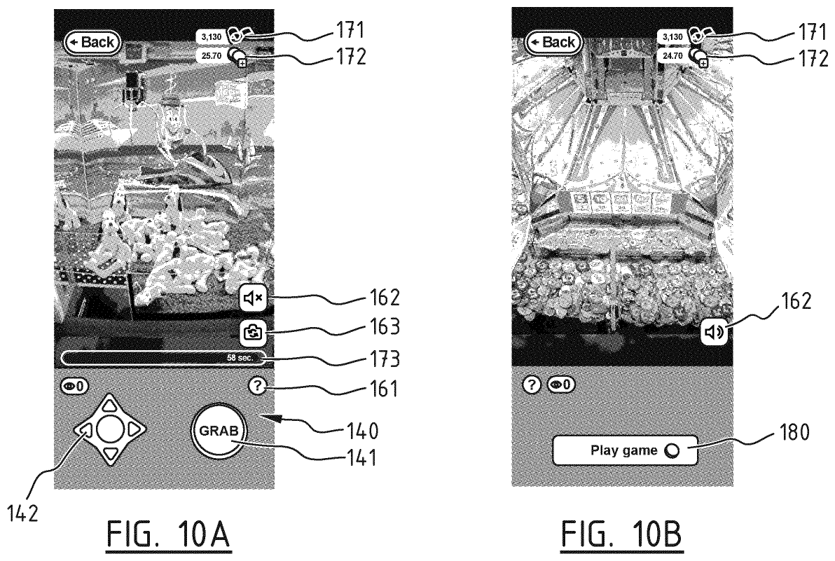

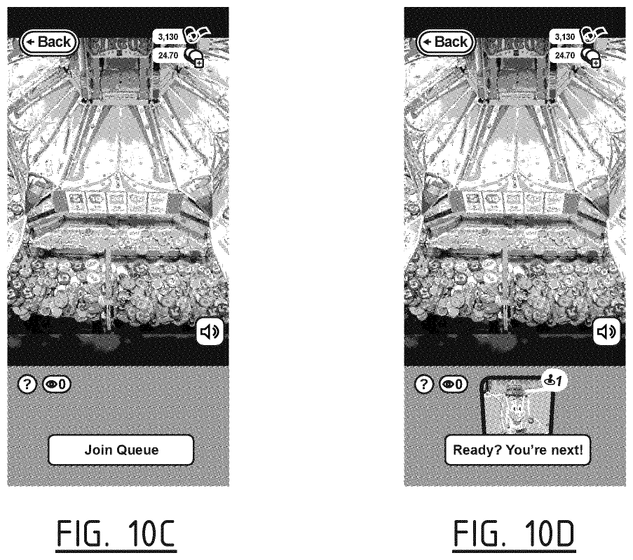

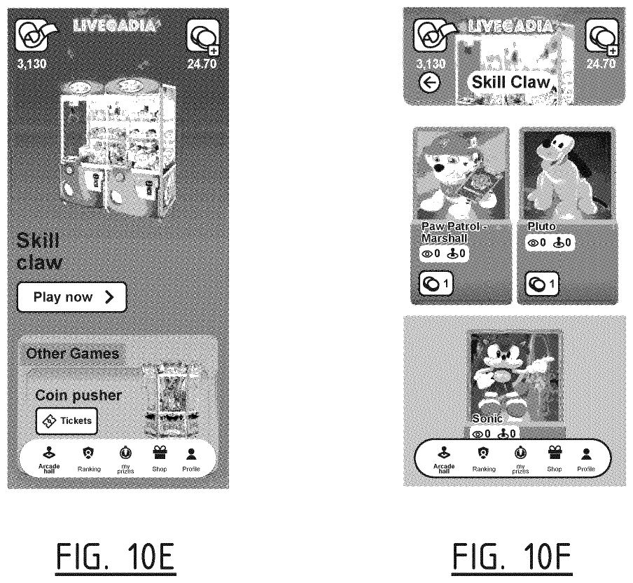

As illustrated in FIGS. 9A and 9B, preferably, the machine further comprises at least one camera 50, 50′ arranged for obtaining images of at least a portion of the playing area 70, and the control means 30 is further configured for receiving images from the at least one camera 50, 50′ and for sending said images, optionally in processed form, to a remote device 2, 2′. For example, the machine may comprise a top camera 50 and/or a front camera 50′. The front camera 50′ may be arranged inside the housing 10, see FIG. 9B, or outside the housing 10, see FIG. 9A. Such images may be sent whilst a player is playing an on-line game and/or whilst playing off-line and/or in an idle status when no one is playing. In a preferred embodiment, the top camera 50 is attached to the pick-up means 21 or to the positioning means 22 illustrated in FIGS. 1-4. For example, the camera may be attached to a carriage of the positioning means, wherein the pick-up means are attached to the carriage and the carriage is moveable in an X-Y plane, typically in an upper part of the housing. Preferably, the remote device 2, 2′ is provided with a display for displaying a window including an image of the machine and one or more controllable items such as virtual buttons, etc. This is illustrated in FIGS. 10A-10F displaying windows which may be displayed on the display of a remote device 2, 2′.

FIG. 10A shows a window which may be displayed on a screen of a remote device whilst playing a claw machine type game online. The window includes an image captured by the front camera 50′, a virtual user interface 140 with a “grab” button 141 and positioning buttons 142 for positioning the pick-up means, and further optional buttons, such as a help button 161, a sound button 162 to control the sound, a button 163 to switch between camera feeds from camera 50 or 50′, game information such as a ticket wallet 171, a token wallet 172, a game timer 173, etc.

FIG. 10B shows a window which may be displayed on a screen of a remote device for playing a pusher-type game online. The game may be started by pushing the “Play game” button 180. FIG. 10C shows a window which may be displayed on a screen of a remote device when someone else is playing the pusher-type game. In that case, the player may decide to join the queue by pushing the “Join Queue” button 181. When the game is finished or almost finished, the window shown in FIG. 10D may be displayed to indicate that the player is next.

FIGS. 10E and 10F illustrate game selection screens which may be first displayed to a player, so as to allow a player to choose the game he wants to play. After a player selects in the window of FIG. 10E the “Skill claw” type game, the window of FIG. 10F may be displayed to allow a player to choose between different “Skill claw” games, e.g. games with different prizes.

More generally, any of the following information or a combination thereof may be displayed on a display of the remote device:
status, e.g., whether or not someone is playing online or offline;
a link such as a QR-code to the online website to play online;
the online queue;
the number of players in the queue and/or the expected time until it is your turn to play;
a timer which counts down and allows to start the next game;
image captured by a camera 50, 50′ of the machine;
animation and artwork to entertain the player.

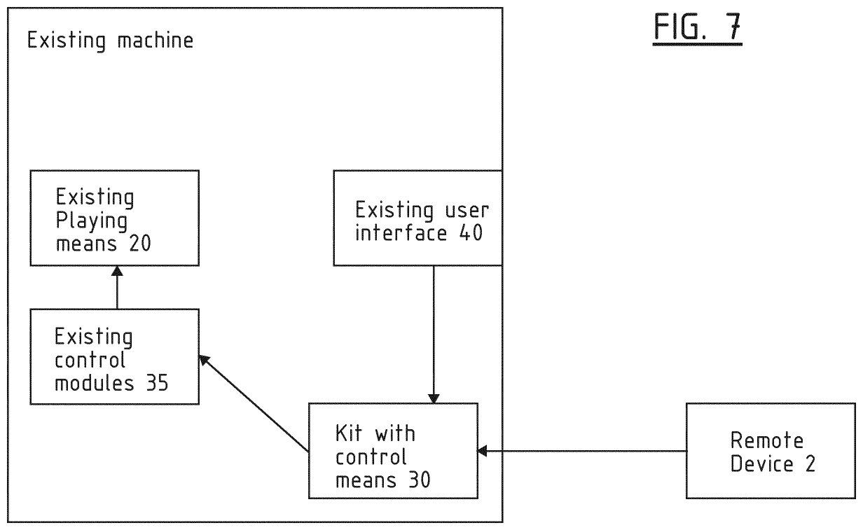

It is noted that the at least one camera 50, 50′ may be added to an existing claw machine. Further, it is noted that the control means 30 may be added to an existing claw machine and may be connected to existing control modules of a claw machine used to control the pick-up means 21 and the positioning means 22. In that case the control means 30 may function as a kind of switching device between the user interface 40 and the existing control modules, and may be configured to send signals to the existing control modules which are either based on signals from the user interface 40 or based on signals received from the remote device 2, 2′ depending on whether an offline or an online player is playing. If a new claw machine is designed, the function of the control means 30 and of the existing control modules may optionally be grouped in a single control unit. This is illustrated in general for any kind of machine in FIG. 7. A kit with the control means 30 and optionally some cabling and/or a display may be added to an existing machine to allow the existing machine with an existing control module 35 to operate both in an offline and an online mode.

When it is desirable to operate in an automatic mode and to use the playing means 20 for performing the transport of objects back to the playing area 70, the control means 30 may be configured to control the positioning means 22 to lower the pick-up means 21 with a won object in a win chute without dropping the object, and to lift the object up again out of the win chute with the won object, whereupon the positioning means 22 by the control means 30 are controlled to move the object back above the playing area followed by controlling the pick-up means 21 to drop the object.

Optionally, the machine further comprises a detection means (not shown) configured for detecting a prize P won by an online or offline player, and the control means 30 is configured to receive a detection signal from the detection means and to inform the online or offline player accordingly.

Thus, as explained above, the arcade machine, e.g. a claw machine, may have an online queuing system, allowing players to understand when it is their turn to play (cf. (i) above).

This queuing system may run on a cloud-based platform and can therefore be accessed anywhere with a reliable internet connection, so both in the arcade and outside of it. To that end the control means 30 may communicate with the cloud-based platform.

As explained above, this queuing system may be visualized on a monitor/display 60 attached to the machine. The control means 30/monitor 60 may be configured such that players can interact with this monitor 60 to visualize their spot in the queue, expected waiting time until their turn and explaining them the difference between playing online and offline in terms of control and outcome (cf. (ii) above).

Preferably, if the connection to the internet is lost, the machine goes offline. Online players are presented with an error message and diverted to a different machine.

To ensure prizes are dispensed outside of the machine only when the winning player is physically standing in front of the claw machine, and not when the winning player is an online player, the machine may be provided with a system to distinguish between playing the game in an open loop and closed loop fashion. Thus, the control means 30 may be configured to allow a prize P to fall in a compartment 81 which is accessible to an offline player when the machine is operating in the offline mode and may be configured to automatically bring a prize back to the playing area 70, e.g. using transport mechanism 90 or playing means 20, when the machine is operating in the online mode.

Typically, prior art claw machines are open loop: the player grabs a prize, drops this in the prize chute, accesses the prize chute through an open valve door, takes out the prize and walks away with it.

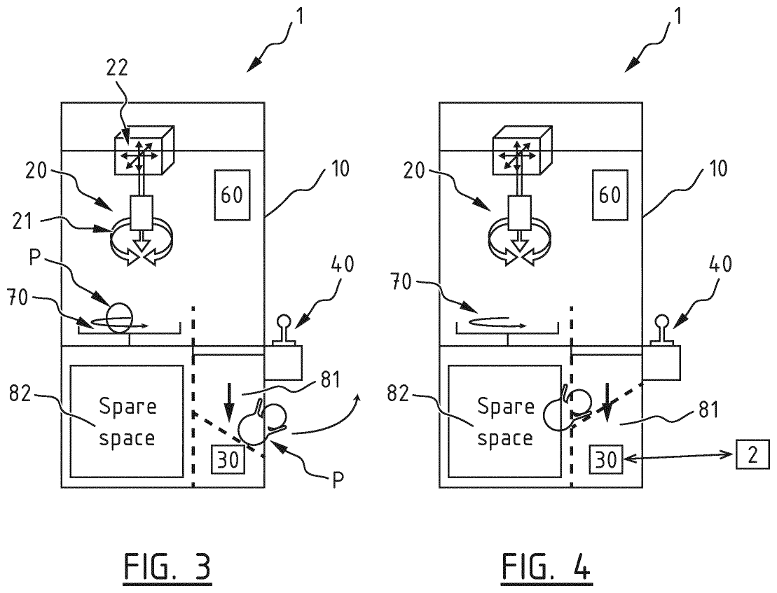

Embodiments of the invention may include a multi-directional prize chute; working in 4 modes, when a prize is won.
1. Prize falls must be registered by the operator and manually be put back in the playing area / playfield 70. Prize will sit on platform waiting for the operator and will manually be put back in the playfield 70, see FIG. 1;
2. The prize will be registered automatically by the game machine; a prize coupon will be given to the player and the prize will be dispensed back to the playfield 70. This can be in an online or offline configuration. The playfield 70 is stationary or rotating or has a built-in rotator 75 to ensure an equal and fair distribution of the prizes, see FIG. 2;
3. The prize will be registered automatically by the game machine and given out to the player who is playing in front of the machine, meaning offline, see FIG. 3;
4. The prize will be registered automatically by the game machine, the online player will receive a voucher and the prize will be dispensed in a spare space 82 not accessible for the offline player, see FIG. 4.

Embodiments of the invention allow for a machine to be operated in an online and offline mode. In any of the four scenarios, a signal may be sent out through an API to indicate a win.

A claw machine may work in the following known way: the player tries to put the claw to be directly above the prize with a joystick or directional buttons (part of the user interface 40), then presses the grab button (part of the user interface 40). The claw drops with open fingers onto the prizes, and closes its fingers. If the claw is positioned correctly, the prize is lifted up and then placed above the prize chute, the claw fingers open and the prize drops into the prize chute. The win may be recognized by the prize passing a detector. Existing claw machine typically operate in an open loop, but as explained above, claw machine of the invention may operate in a closed loop or in an open loop.

In embodiments of the invention, the claw machine may work in the following closed-loop ways: the player tries to put the claw to be directly above the prize with a joystick or directional buttons, then presses the grab button. The claw drops with open fingers onto the prizes, and closes its fingers. If the claw is positioned correctly, the prize is lifted up and then placed above the prize chute, the claw fingers stay shut and the claw (with the prize in its fingers) is lowered into the prize chute, passing the detector to recognize the win. The claw +prize then lift up again and the claw positions the prize back onto the playfield in the position it came from or one randomly chosen. Another possibility is for the claw to drop the winning prize into the prize chute. The prize chute door stays locked and the claw drops in the prize chute grabbing the prize, lifting it out of the chute and positioning it back onto the playfield in the position it came from or one randomly chosen.

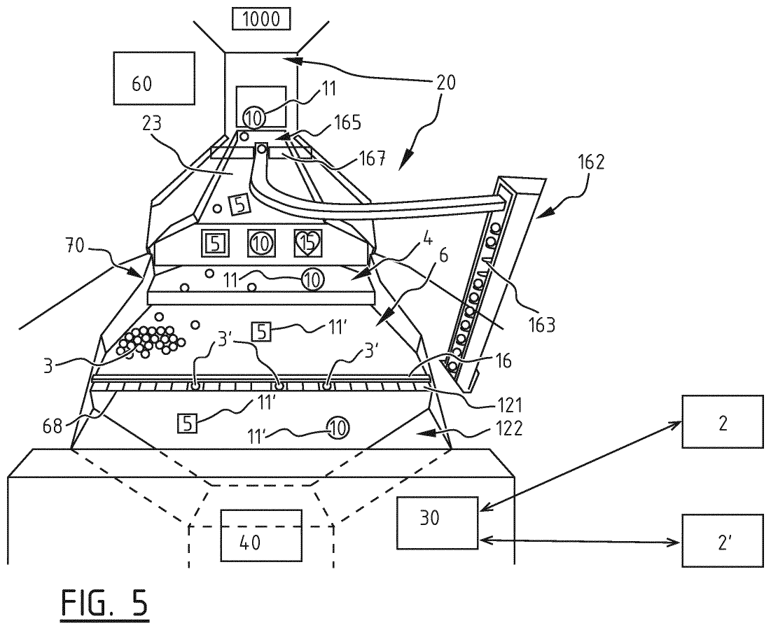

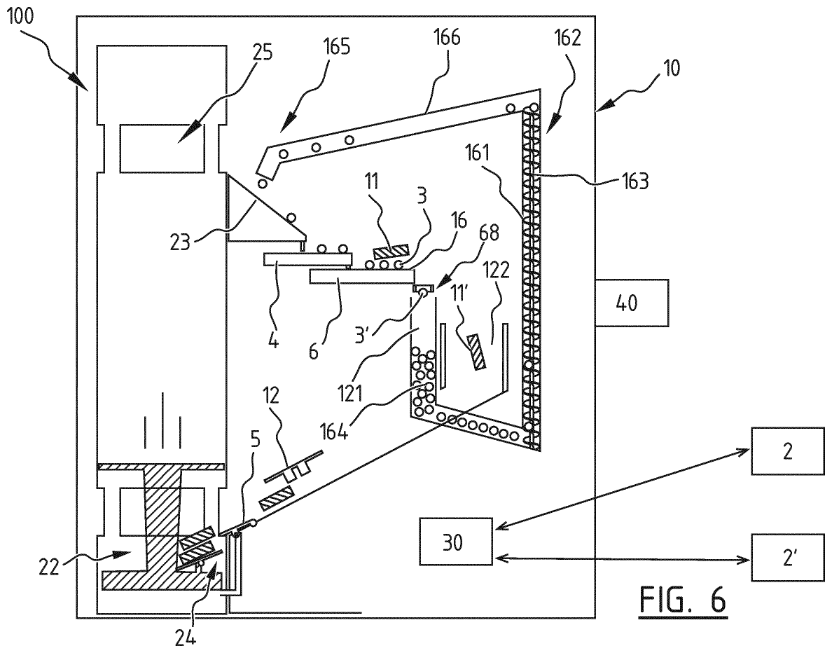

FIGS. 5 and 6 illustrate an embodiment of an amusement machine of the pusher type. The amusement machine comprises a housing (not visible, but surrounding the playing area 70) with a playing area 70 and a playing means 20 comprising object manipulation means for adding one or more prizes 11 and/or one or more playing pieces 3 in the playing area 70. The machine further comprises a control means 30 configured for controlling the playing means 20, and a user interface 40 (shown schematically as a rectangle), such as one or more buttons and/or a joystick, provided to the housing and controllable by an offline player. The user interface 40 is configured to generate signals to control the playing means 20. The control means 30 is configured to receive signals to control the playing means 20, from a remote device 2, 2′ of an online player, such as a home computer or a mobile device of the online player, to play a game online. The control means 30 is configured to operate in an offline mode or in an online mode, wherein in the offline mode the control means 30 is configured to allow the use of signals received from the user interface 40, and wherein in the online mode the control means 30 is configured to use signals received from the remote device 2, 2′.

The playing area 70 comprises typically a horizontal surface 6 on which are supported a plurality of playing pieces 3, such as coins, chips or marbles, as well as a number of prizes 11. If marbles are used for gameplay, playing surface 70 can for instance be provided with corrugations. Note that playing surface 6 need not necessarily be horizontal, and can also be placed at a slight angle of inclination. Prizes 11 are typically larger than playing pieces 3, and there are typically fewer prizes 11 than playing pieces 3, for instance less than one prize 11 for at least ten playing pieces 3. A playing piece pusher 4 is configured to move over playing surface 6 at successive points in time in order to disturb the plurality of playing pieces 3 and prizes 11 supported on playing surface 6. During movement of the playing piece pusher 4, one or more playing pieces 3 and/or prizes 11 can drop over an edge 16 of playing surface 6, see reference numerals 3′ and 11′. The playing piece pusher 4 can for instance be a plate (box) which moves reciprocally over playfield 6 in the direction of edge 16. In the case of a multiplayer machine the playing piece pusher can also be one central plate or box which moves over the different playing surfaces 6 of the multiplayer machine.

The embodiment of FIGS. 5 and 6 show one playing area 70 of machine, and in case of a single-player machine one playing area 70 is included in a housing. In case of a multiplayer, for instance a six-player with six playing areas, multiple playing areas 70 are included in a housing. The skilled person will appreciate that the multiplayer can for instance be a two-player, a three-player, a four-player, a six-player and so on.

As shown in FIG. 6, the amusement machine comprises a playing means 20 with a transport system 100 with a first closed transport loop for prizes 11 and with a second closed loop for playing pieces 3. The transport system 100 comprises a sorting and discharge mechanism 68 for discharging playing pieces 3′ to a second discharge channel 121, and for discharging prizes 11′ to a first discharge channel 122. The sorting and discharge mechanism 68 may be an elongate grid with suitable mesh dimensions such that the playing pieces 3′ fall through the grid 68 into the second discharge channel 121 and the prizes 11′ pass over the grid 68 into the first discharge channel 122. The grid 68 extends along the edge 16 of the playing surface 6, and the second discharge channel 121 is located below the grid 68. The first discharge channel 122 is located in front of the second discharge channel 121 such that prizes 11′ passing over grid 68 fall into the first discharge channel 122. Typically, the mesh dimensions will be smaller than the dimensions of a prize 11 and bigger than the dimensions of a playing piece 3. The first discharge channel 122 has an outlet which connects to a first collecting location 24. The second discharge channel 121 has an outlet which connects to a second collecting location 164. In another exemplary embodiment (not shown), the sorting and discharge mechanism comprises a number of mutually spaced rollers through which the smaller playing pieces drop downward in a second discharge channel or directly in the second collecting location and over which the larger prizes are transported to a first discharge channel or directly to the first collection location.

Provided between first collecting location 24 and first infeed location 25 is a first lift module 22 configured to transport the prizes 11 collected in first collecting location 24. When first lift module 22 is in a low position, prizes 11 which have dropped over edge 16 come to lie in first collecting location 24. When first lift module 22 is in a high position, prizes which have been carried upward can be reintroduced onto playfield 6 from first infeed location 25. Optionally, a closing means such as a gate 5 can be provided between outlet of first discharge channel 122 and first collecting location 24 for temporarily holding back one or more prizes.

A detection module 12 can for instance be provided along first discharge channel 122, after sorting and discharge mechanism 68, for detecting one or more prizes 11 in first discharge channel 122. Detection module 12 can for instance be an RFID reader module, and prizes 11 can for instance be provided with an RFID tag which is readable by the RFID reader module. Detection module 12 can co-act with an award module for awarding a number of prize points to the player in accordance with the detected prize 11. Optionally, the award module is part of the control means 30. Alternatively, the award module is a separate unit communicating with the control means 30. Following detection of a prize 11, the prize 11 slides in the direction of gate 5, wherein the gate can be opened as soon as the first lift module 22 is in the low first collecting location 24. The one or more prizes 11 slide into the first lift module 22 and first lift module 22 is moved to the higher first infeed location 25. At the higher first infeed location 25 the one or more prizes 11 can slide over incline 23 to playing surface 6. The one or more prizes 11 come to lie on playing surface 6 by moving the pusher 4, and the cycle begins again.

Provided between second collecting location 164 and a second infeed location 165 is a second lift module 162 configured to transport playing pieces 3 collected in second collecting location 164. The second lift module 162 may comprise an Archimedes screw 163. Playing pieces 3 are collected in second collecting location 164 and transported upward by screw 163 which rotates in a cylinder 161. In an alternative embodiment, the second lift module comprises a hopper module (not shown), for instance an escalator hopper, which is configured to move playing pieces upward in an orderly row from the second collecting location to the second infeed location. When playing pieces 3 reach the top of the second lift module 162, they can be carried back onto playfield 6, for example via a chute 166 which is configured to dispense the playing pieces 3 on an inclined surface 23. The playing pieces 3 slide or roll on the inclined surface 23, on the playfield 6 via pusher 4. Optionally, there may be provided a guide piece 167 at a distance above the inclined surface 23 to ensure that playing pieces 3 follow the incline 23 as they move towards the playfield 6. Playing pieces 3 circulate in a second closed loop, via second discharge channel 121, second lift module 162 and chute 166. Instead of chute 166, there may also be provided a swing arm which connects to the second infeed location 165 and is configured to move over playing surface 6. Such swing arm may be configured to guide playing pieces 3 through swing arm and to an outlet of swing arm, which outlet is located above playing surface 6.

The first lift module 22 comprises drive means (not shown) for moving first lift module 22 vertically upward from the first collecting location 24 to the first infeed location 25 and back, and a control module which may be part of control means 30 or may be a separate unit communicating with control means 30, for controlling the drive means in accordance with a state of the game, for instance when a player still has sufficient credits. The second lift module 162 is configured to move playing pieces 3 upward in an orderly row from the second collecting location 164 to the second infeed location 165. Playing piece counting means (not shown) can optionally be provided for counting the number of playing pieces. This counted number can then be passed on to the award module for awarding extra credits or points to the player. Optionally, the user interface 40, e.g. comprising a button and/or a joystick, is configured for controlling the adding of playing pieces 3 by an offline player, e.g. via the screw 163 and chute 166 or via a swing arm.

In an exemplary embodiment the control module is configured to operate the first lift module 22 when a predetermined number of prizes has been collected in the first collection location 24, e.g. 5 prizes. When the predetermined number of prizes has been collected, the gate 5 is closed and the first lift module is moved upwardly to dispense the prizes from the first infeed location 25 back on the playing surface 26. The control module is further connected with the user interface 40, such as a button and/or a joystick, and is configured to control the adding of a playing piece in function of the inputs of the player input via the user interface 40. E.g., whenever the player presses a button, a playing piece is added on the playing surface 6.

In the embodiment of FIGS. 5 and 6, two separate lift modules are provided. However, in other embodiment, there may be provided a common lift module for prizes and playing pieces, and the first and the second lift module may have certain parts in common.

An advantage of an embodiment with a closed-loop system is that an operator of the amusement machine can present a game which is attractive to the player and which requires no or hardly any assistance in refilling the amusement machine and/or reading prizes 11.

The skilled person will appreciate that transport system 100 can also be implemented in other ways. The transport system can thus consist of a plurality of mutually connecting conveyor belts, wherein the lift system can for instance be a conveyor belt running upward. In addition, it is also possible to provide two parallel lift modules centrally, a first for playing pieces 3 and a second for prizes 11, wherein playing pieces 3 and prizes are pre-sorted. Additional infeed means controllable by the user interface 40 could then be provided which allow the timing of the reintroduction of playing pieces 3/prizes 11 to be influenced.

The skilled person will also appreciate that, instead of two platforms (playfield 6 and pusher 4), more than two platforms can also be provided, wherein one or more of the platforms are movable.

The user interface 40 may be provided a sidewall of the housing, and may be used for controlling the adding of a playing piece 3 on playfield 6 and/or for controlling the moving of an additional arm (not shown, cf. the swing arm described above) with which playing pieces 3 can be thrown onto playfield 6. A display screen 60 may be provided above each playfield 6. The credits of an offline player can for instance be stated on this display screen 60. A payment module (not shown) may further be provided in a wall of the housing. This payment module can for instance be configured for purchase of credits with cash (coins and/or notes) or for purchase of credits with other payment means, such as a credit card.

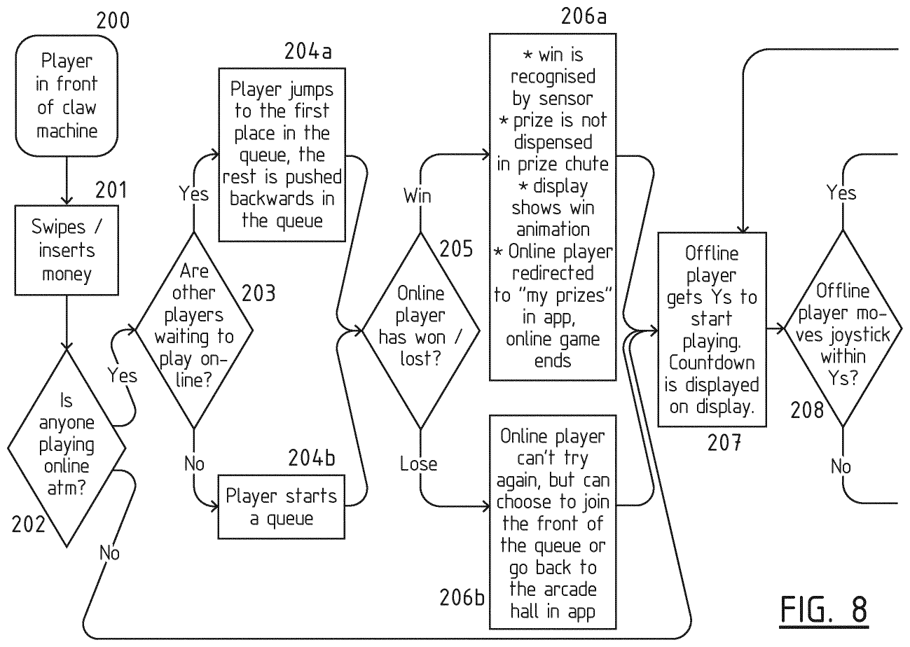

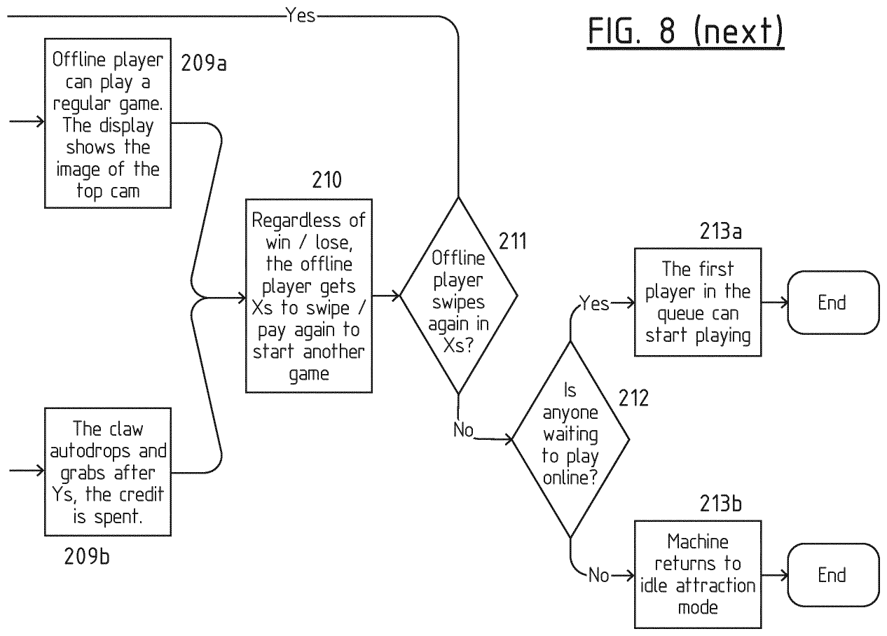

FIG. 8 illustrates a sequence of steps controlled by an exemplary embodiment of a control means. It is assumed that an offline player is in front of a claw machine, see 200. This may be a claw machine 1 as illustrated in FIGS. 1-4 with a control means 30 and a display 60. In a first step 201, the offline player inserts money or pays in another way for playing a game. In a second step 202, the control means checks if an online player is playing an online game. If this is the case, in step 203, the control means checks if any other online players are waiting online. If this is the case, in step 204a, the control means puts the offline player before the online player(s) in the queue. If this is not the case, in step 204b, a queue is created for the offline player. If the online player that is currently playing has won the game, the online player may be directed to a prize section of the software and the online game ends, see steps 205 and 206a. Optionally, the control means may control the display so as to display a win animation. If the online player that is currently playing has lost the game, the online player may choose to join the queue again or may go to an arcade hall section of the software to watch on offline player playing, see steps 205 and 206b. Alternatively, steps 205-206a/b may be replaced with a step in which an online player is given a predetermined period of time to finish his game. In the next step 207, the offline player gets a predetermined number of Y seconds to start playing, and optionally a countdown may be displayed on the display. In step 208, it is checked if the offline player has moved the joystick within this predetermined period of time. If yes, in step 209a, the offline player plays a regular game. Optionally, the display may show an image captured by a top camera mounted in the housing. If no, in step 209b, the grabber grabs and the credit is spent. In step 210, regardless of whether the offline player has won or lost the game and regardless of whether online players are waiting in the queue, he gets another opportunity to pay for a next game. If he pays within a predetermined time period of X seconds, see step 211, steps 207 to 210 are repeated. If he does not pay within the predetermined time period, the control means checks if an online player is waiting, see step 212. If yes, the online player can start playing, see step 213a; if no, the machine moves into an idle attraction mode, see step 213b.

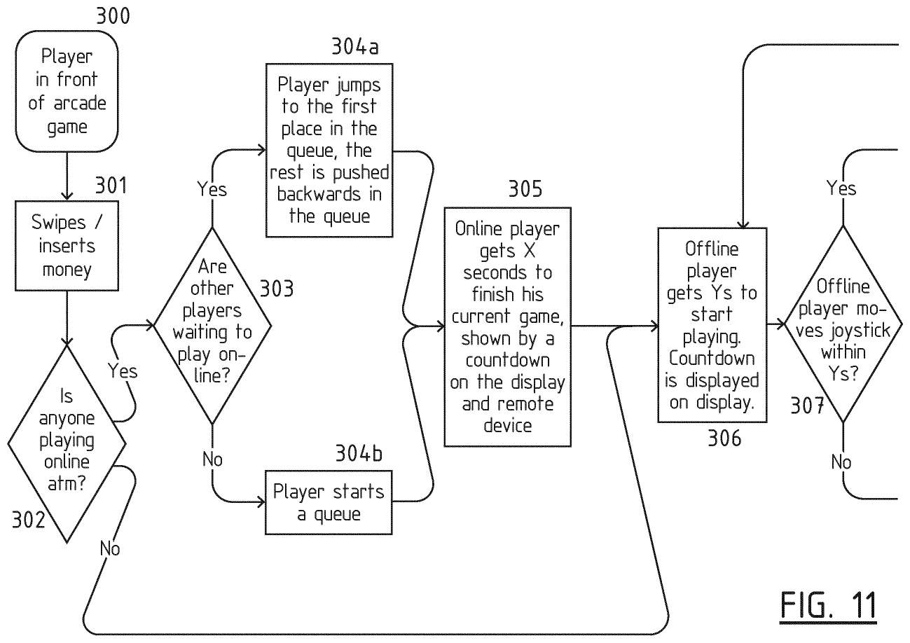

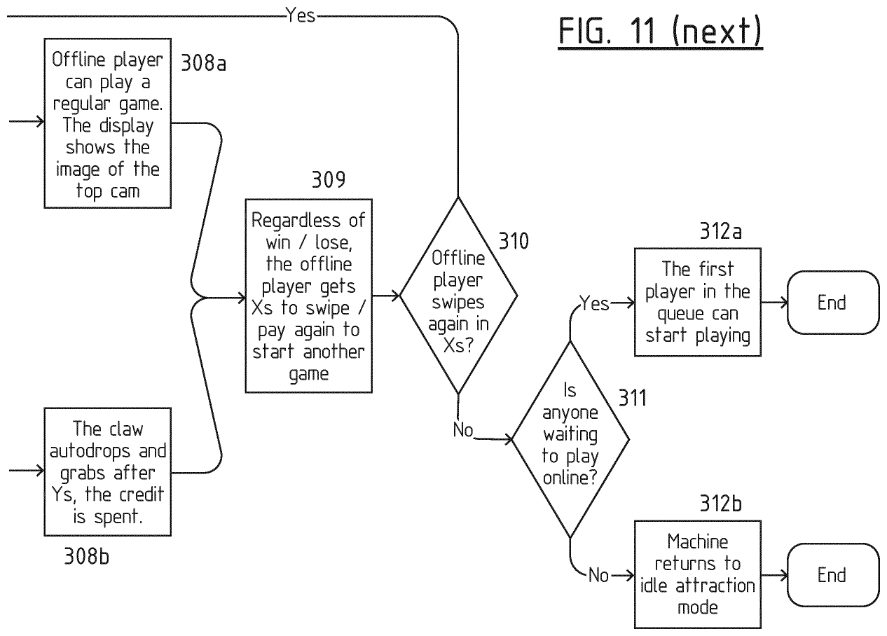

FIG. 11 illustrates a sequence of steps controlled by an exemplary embodiment of a control means. It is assumed that an offline player is in front of a machine, see 300. This may be for example a redemption machine. In a first step 301, the offline player inserts money or pays in another way for playing a game. In a second step 302, the control means checks if an online player is playing an online game. If this is the case, in step 303, the control means checks if any other online players are waiting online. If this is the case, in step 304a, the control means puts the offline player before the online player(s) in the queue. If this is not the case, in step 304b, a queue is created for the offline player. In step 305, the online player gets X seconds to finish the game, for example shown by a countdown on a display of the machine and/or on the remote device of the online player. The number of seconds X may be configurable by an operator. In step 306, the offline player gets Y seconds to start playing the game, for example shown by a countdown on a display of the machine. The number of seconds Y may be configurable by an operator. In step 307, it is checked if the offline player has moved the joystick within this predetermined period of time. If yes, in step 308a, the offline player plays a regular game. Optionally, a display of the machine may show an image captured by a top camera mounted in the housing. If no, in step 308b, the grabber auto-grabs and the credit is spent. In step 309, regardless of whether the offline player has won or lost the game and regardless of whether online players are waiting in the queue, he gets another opportunity to pay for a next game. If he pays within a predetermined time period of X seconds, see step 310, steps 306 to 309 are repeated.

If he does not pay within the predetermined time period, the control means checks if an online player is waiting in the queue, see step 311. If yes, the online player can start playing, see step 312a; if no, the machine moves into an idle attraction mode, see step 312b.

The invention is not limited to the above-described embodiments and the skilled person will appreciate that many modifications and variants can be envisaged within the scope of the invention, which is defined solely by the following claims.

1. A game or amusement machine such as a claw machine or a machine of the pusher type or any other arcade redemption or merchandising game, comprising:
a housing with a playing area and a playing means
a control means configured for controlling the playing means, and
a user interface, such as one or more buttons and/or a joystick, provided to said housing and controllable by an offline player, said user interface being configured to generate signals to control the playing means;
wherein said control means is configured to receive signals to control the playing means, from a remote device of an online player, such as a home computer or a mobile device of the online player, to play a game online;
wherein the control means is configured to operate in an offline mode or in an online mode, wherein in the offline mode the control means is configured to allow the use of signals received from the user interface, and wherein in the online mode the control means is configured to use signals received from the remote device.

2. The machine of claim 1, further comprising at least one camera arranged for obtaining images of at least a portion of the playing area, wherein said control means is further configured for sending images obtained by the camera, optionally in processed form, to the remote device.

3. The machine of claim 1, further comprising one or more objects, such as one or more prizes, in said playing area, wherein the playing means is configured to manipulate the one or more objects.

4. The machine of claim 3, wherein the housing is provided with a first compartment which is freely accessible to an offline player and a second compartment which is not freely accessible to an offline player, and wherein the control means is configured to move an object to the first compartment when playing in the offline mode and to the second compartment when playing in the online mode; wherein preferably the housing is provided with a lockable door to access the second compartment.

5. (canceled)

6. The machine of claim 3, wherein the control means is configured to issue a voucher to an online and/or offline player when an object, such as a prize is won and moved to a non-accessible compartment or back to the playing area.

7. The machine of claim 3, further comprising a transport mechanism, optionally comprising the playing means, configured to transport one or more objects won by an offline and/or an online player back to the playing area, and wherein the control means is configured to issue a voucher to the offline and/or online player; and/or further comprising an object movement means, such as a rotator, configured to move an object in the playing area.

8. (canceled)

9. The machine of claim 3, wherein the control means is configured to be set in at least two of the following modes, preferably all three of the following modes:
a. a manual mode in which an object won by an offline or online player is to be put back on the playing area by an operator; wherein the control means is configured to send a message to an operator when an object is won;
b. an automatic mode in which an object won by an offline or online player is automatically dispensed back to the playing area;
c. a prize dispensing mode in which an object won by an offline or online player is dispensed to a compartment.

10. The machine of claim 1, wherein the user interface is configured for allowing an offline player to input a request to play a game using the user interface;
wherein said control means is further configured to receive an online request to play a game online, from the remote device;
wherein the control means is configured to schedule a sequence of games based on requests received from the user interface and/or from the remote device; and to use signals received from the user interface or signals received from the remote device, according to the scheduled sequence.

11. The machine of claim 10, wherein the control means is provided with a queuing mechanism configured to order and store the received requests, wherein the queuing mechanism is configured to give priority to a request received from the user interface, and preferably to put a request received from the user interface before any pending online requests stored in the queuing mechanism.

12. (canceled)

13. The machine of claim 10, wherein the control means is configured to end a game that is being played online within a determined time period when a request is received from the user interface; and/or wherein the control means is configured to inform the remote device and/or the offline player that a game will be ended within a determined time period when a request is received from the user interface.

14. (canceled)

15. The machine of claim 10, wherein the housing is provided with a display connected to the control means and configured to display a list of offline and/or online players associated with scheduled sequence of games.

16. The machine of claim 1, wherein the playing means comprises a pick-up means, such as a claw device, a grabber or vacuum head, configured to pick-up one or more objects; wherein the playing means further comprises a positioning means controllable by the user interface or the remote device for placing the pick-up means over one or more objects.

17. (canceled)

18. The machine of claim 16, further comprising at least one camera arranged for obtaining images of at least a portion of the playing area, wherein said control means is further configured for sending images obtained by the camera, optionally in processed form, to the remote device, wherein a camera of said at least one camera is attached to the pick-up means and/or to the positioning means.

19. The machine of claim 16, wherein the control means is configured to control the positioning means and the pick-up means to bring a won object back in the playing area after an offline or online player has won an object, wherein the control means is configured to lower the pick-up means with a won object in a win chute without dropping the object, and to lift the object up again out of the win chute with the won object, whereupon the positioning means are controlled to move the object back above the playing area followed by controlling the pick-up means to drop the object.

20. (canceled)

21. The machine of claim 1, wherein the playing means comprises a manipulation device configured to add and/or manipulate one or more objects, such as one or more prizes and/or one or more playing pieces, such as coins, tokens, chips and/or balls, in the playing area.

22. (canceled)

23. The machine of claim 3, wherein the one or more objects comprise a plurality of playing pieces and optionally one or more prizes in the playing area, further comprising a playing piece pusher configured to move over the playing area at successive points in time in order to disturb the playing pieces and the optional one or more prizes in the playing area, wherein the playing area and the playing piece pusher are arranged such that one or more playing pieces and/or prizes can drop over an edge of the playing area during movement of the playing piece pusher.

24. (canceled)

25. (canceled)

26. (canceled)

27. (canceled)

28. A control means for use with a game or amusement machine comprising a playing means and a user interface manipulable by an off-line user to control the playing means,
said control means being configured to operate in an offline mode or in an online mode;
wherein the control means is configured to receive signals to control the playing means, from a remote device of an online player, such as a home computer or a mobile device of the online player, when in the on-line mode;
wherein the control means is configured to allow using signals received from the user interface, when in the off-line mode.

29. The control means of claim 28, wherein the control means is configured to receive an online request to play a game online, from the remote device;
wherein the control means is configured to schedule a sequence of games based on requests received from the user interface and/or from the remote device; and to control the machine so as to use signals received from the user interface or signals received from the remote device, according to the scheduled sequence.

30. The control means of claim 29, wherein the control means is provided with a queuing mechanism configured to order and store the received requests; wherein the queuing mechanism is configured to give priority to a request received from the user interface, and preferably to put a request received from the user interface before any pending online requests stored in the queuing mechanism.

31. (canceled)

32. The control means of claim 28, wherein the control means is configured for sending images of at least a portion of a playing area of the machine, optionally in processed form, to the remote device, said images being obtained by a camera associated to the machine; and/or wherein the control means is configured to end a game that is being played online within a determined time period when a request is received from the user interface; and/or wherein the control means is configured to inform the remote device and/or the offline player that a game will be ended within a determined time period when a request is received from the user interface.

33. (canceled)

34. (canceled)

35. (canceled)

36. (canceled)

37. A game or amusement machine, such as a claw machine or a machine of the pusher type or any other arcade redemption or merchandising game, comprising:
a housing with a playing area and a playing means;
one or more objects, such as one or more prizes, in said playing area, wherein the playing means is configured to manipulate the one or more objects;
a control means configured for controlling the playing means, and
a user interface such as one or more buttons and/or a joystick, provided to said housing and controllable by a player, said user interface being configured to generate signals to control the playing means;
wherein the control means is configured to be set in at least two of the following modes, preferably all three of the following modes:
a manual mode in which an object won by a player is to be put back on the playing area by an operator; wherein preferably the control means is configured to send a message to an operator when an object is won;
an automatic mode in which an object won by a player is automatically dispensed back to the playing area; wherein preferably the object won may be automatically returned to the playing area using a transport mechanism;
a prize dispensing mode in which an object won by a player is dispensed to a compartment.

38. The game or amusement machine of claim 37, wherein, in the prize dispensing mode, when the machine is operating in an offline mode, the object won is registered automatically by the game or amusement machine and given out to the player who is playing in front of the machine.

39. The game or amusement machine of claim 37, wherein, in the prize dispensing mode, when the machine is operating in an online mode, the object won is registered automatically by the game or amusement machine, is placed in a spare compartment, and a voucher is provided to the on-line player.
